(19) United States
(12) Patent Application Publication
(10) Pub. No.: US 2008/0105273 A1
(43) Pub. Date: May 8, 2008

(54) Personal-care product applicator

(76) Inventors: Jane Marilyn Seeland, Cliffwood Beach, NJ (US); Janet Rose Collins, Cliffwood Beach, NJ (US)

Correspondence Address: JANE MARILYN SEELAND, 8 WEST CONCOURSE, CLIFFWOOD BEACH, NJ, 07735, US

(21) Appl. No.: 11/981,918

(22) Filed: Oct. 31, 2007

Related U.S. Application Data
(60) Provisional application No. 60/857,372, filed on Nov. 7, 2006.

(51) Int. Cl. A45D 33/00; A45D 40/26; A46B 5/02; B05C 11/00

(52) U.S. Cl. 132/200; 132/320; 401/266; 401/6

(57) ABSTRACT

A personal-care product applicator designed for applying a variety of substances including liquid, solid, lotion, foam, gel, cream, powder, ointment, oil, spray and salves to the physical body, including hard to reach areas. The applicator comprises: A device having an elongated handle portion at the proximal end and a dispensing pocket mounted to the underside of the body portion at the distal end thereof. The dispensing pocket formed of a permeable material, as to enable a substance to flow through, has an inlet opening, the inlet opening has a closure for sealing. The dispensing pocket is designed for receiving, retaining, then dispensing and applying a substance to the physical body. The substance is placed into the dispensing pocket where it is retained, while being maneuvered to the desired area of the physical body. The substance is dispensed directly through, and applied by the dispensing pocket, when smoothed over the skin.

This application claims the benefit of provisional patent application Ser. No. 60/857,372, filed Nov. 7, 2006 by the present inventors.

### FEDERALLY SPONSERED RESEARCH

Not Applicable

### SEQUENCE LISTING OR PROGRAM

Not Applicable

### BACKGROUND OF THE INVENTION

1. Field of the Invention

The present invention relates to lotion applicators and more particularly to a new personal-care product applicator for dispensing and applying lotions and a wide variety of other substances including liquid, solid, foam, gel, cream, powder, ointment, oil, spray and salves to the physical body, including hard to reach areas.

2. Description of the Prior Art

It is occasionally necessary to apply personal-care products to one's own body, including hard to reach areas. Such application is sometimes difficult, if not impossible, without assistance, especially for elderly or handicapped individuals.

With increased publicity about the potential health risks associated with exposure to the sun, it is important that all individuals, both young and old, be protected. It is suggested that the dangers of sunburn, sun poisoning and even skin cancer can be reduced by using sun block or sunscreen products. Many times a need arises to use these and other personal-care products when an individual is alone.

Personal-care products come in a wide variety of substances, including liquid, solid, lotion, foam, gel, cream, powder, ointment, oil, spray and salves. They may be medicated or non-medicated and some are very costly!

There is a strong need for an individual to be able to apply a wide variety of substances including liquid, solid, lotion, foam, gel, cream, powder, ointment, oil, spray and salves to their own body, including hard to reach areas, quickly and efficiently, without waste or spills. There is a long-felt need for a way to accomplish this task.

The use of lotion and other substance applicators is known in the prior art. This is demonstrated by the plethora of designs encompassed by the crowded prior art which have been developed for the fulfillment of countless objectives and requirements.

Known prior art includes U.S. Pat. No. 5,615,962; U.S. Pat. No. 6,523,550 B2; U.S. Pat. No. 6,247,862 B1; U.S. Pat. No. 6,536,970 B2; U.S. Pat. No. 6,045,279; U.S. Pat. No. 7,165,285 B1; U.S. Pat. No. 6,530,707 B1; U.S. Pat. No. 6,726,385 B1; and U.S. Pat. No. 5,991,961; U.S. Pub. No.: US 2006/0008313 A1; U.S. Pub. No.: US 2005/0268416 A1.

While these devices fulfill their respective, particular objectives and requirements there are several limitations and disadvantages associated therewith including (1) the inability to apply a wide variety of substances including liquid, solid, lotion, foam, gel, cream, powder, ointment, oil, spray and salves, (2) the waste of product that is absorbed by sponge-type or porous elements, (3) the requirement of a chamber or container to hold the product, (4) the difficulty of cleaning various elements, especially sponge-type or porous elements, which increases the chance that bacteria may grow and hide therein, (5) the cost to replace sponge-type or porous elements, (6) unattached parts that can become lost and (7) too many components, which increase manufacturing cost and the probability that one of more element will fail.

Despite the teachings of prior art, a long-felt need for an uncomplicated, convenient, effective, affordable device for dispensing and applying a wide variety of substances including liquid, solid, lotion, foam, gel, cream, powder, ointment, oil, spray and salves to one's own body, including hard to reach areas, still exists.

In view of this, the personal-care product applicator according to the present invention substantially departs from the conventional concepts and designs of the prior art, and in so doing provides an apparatus primarily developed for the purpose of dispensing and applying a wide variety of substances including liquid, solid, lotion, foam, gel, cream, powder, ointment, oil, spray and salves to the physical body, including hard to reach areas.

### SUMMARY OF THE INVENTION

Accordingly, the present invention solves the problems of the aforementioned limitations and disadvantages present in the prior art by providing a new personal-care product applicator of uncomplicated construction, that doesn't require replacement parts, can be easily utilized to dispense and apply a wide variety of substances including liquid, solid, lotion, foam, gel, cream, powder, ointment, oil, spray and salves to the physical body, including hard to reach areas, and may be immediately be rinsed and reused.

The general purpose of the present invention, which will be described subsequently in greater detail, is to provide a new personal-care product applicator apparatus and method which has many of the advantages of the product applicators mentioned heretofore and many novel features that result in a new personal-care product applicator which is not anticipated, rendered obvious, suggested, or even implied by any of the prior art product applicators, either alone or in any combination thereof.

To attain this, the present invention generally comprises a device having a body portion with an elongated handle portion. The underside of the body portion having a dispensing pocket mounted thereunto, designed to receive, retain, then dispense and apply a wide variety of substances including liquid, solid, lotion, foam, gel, cream, powder, ointment, oil, spray and salves to the physical body, including hard to reach areas.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before examining at least one embodiment of the invention in detail, it is to be understood that the invention is not limited in it's application to the details of the construction and to the arrangements of the components set forth in the following description or illustrated in the drawings. The invention is capable of other embodiments and of being practiced and carried out in various ways. Also, it is to be understood that the phraseology and the terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart for the spirit and scope of the present invention.

Further, the purpose of the foregoing abstract is to enable the U.S. Patent and Trademark Office and the public, and especially the scientists, engineers and practitioners in the art who are not familiar with patent or legal terms or phraseology, to determine quickly from a cursory inspection in the nature and essence of the technical disclosure of the application. The abstract is neither intended to define the invention of the application, which is measured by the claims, nor is it intended to be limiting as to the scope of the invention is any way.

It is therefore an object of the present invention to provide a new personal-care product applicator apparatus and method which has many of the advantages of the product applicators mentioned heretofore and many novel features that result in a new personal-care product applicator which is not anticipated, rendered obvious, suggested, or even implied by any of the prior art product applicators, either alone or in any combination thereof.

It is another object of the present invention to provide a new personal-care product applicator that is uncomplicated, effective and easily utilized, allowing it's use by all individuals to assist in applying personal-care products. Essentially, acting as an extension of one's own hand.

It is a further object of the present invention to provide a new personal-care product applicator comprising few parts, which can be simply and efficiently manufactured and marketed.

Still a further object of the present invention is to provide a new personal-care product applicator which provides in the apparatuses and methods of the prior art some of the advantages thereof, while simultaneously overcoming some of the disadvantages normally associated therewith.

An even further object of the present invention is to provide a new personal-care product applicator which includes a device having a body portion with an elongated handle portion. The underside of the body portion having a dispensing pocket mounted thereunto, designed to receive, retain, then dispense and apply a wide variety of substances including liquid, solid, lotion, foam, gel, cream, powder, ointment, oil, spray and salves.

Still yet another object of the present invention is to provide a new personal-care product applicator that doesn't require a chamber or container to hold the product.

Still another object of the present invention is to provide a new personal-care product applicator that has no removable or replacement parts.

Yet another object of the present invention is to provide a new personal-care product applicator that has no sponge-type or porous elements, therefore avoiding any absorption of the product by the applicator itself.

Still yet another object of the present invention is to provide a new personal-care product applicator that is easy to clean and reuse.

Even still another object of the present invention is to provide a new personal-care product applicator that can be used with liquid or bar soap in a bath or shower setting.

An even further object of the present invention is to provide a new personal-care product applicator that can be used as a personal-cooling device when an ice cube is placed therein and smoothed over the physical body, including hard to reach areas.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The present invention will be better understood and objects other than those set forth above will become apparent when consideration is given to the following detailed description thereof. Such description makes reference to the annexed drawings wherein:

FIG. 1 is a perspective view of the personal-care product applicator.

FIG. 2 is a top view of the personal-care product applicator.

FIG. 3 is a side view of an alternative embodiment of the personal-care product applicator.

FIG. 4 is a rotated underside view of the personal-care product applicator shown in FIG. 2, illustrating the dispensing pocket.

### REFERENCE NUMERALS

| | | | |
|---|---|---|---|
| 14 | personal-care product | 5 | elongated handle portion |
| | applicator | | |
| 6 | body portion | 7 | finger notches |
| 8 | aperture | 9 | non-porous cushion material |
| 10 | dispensing pocket | 11 | inlet opening |
| 12 | closure | | |

### DETAILED DESCRIPTION OF THE PREFERRED EMBODIMENT

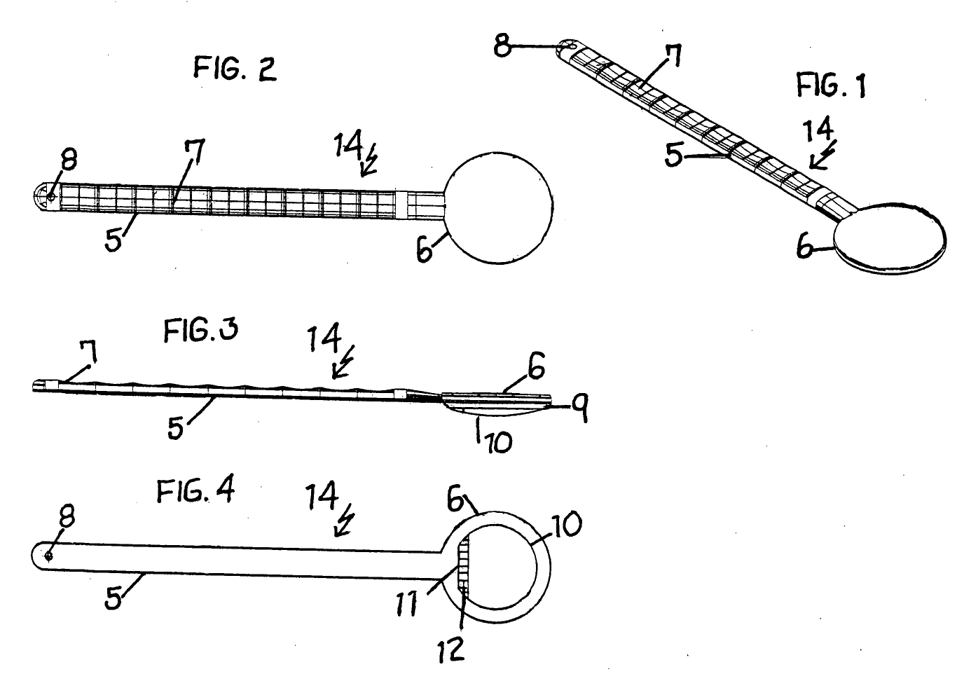

With reference now to the drawings, and in particular to FIG. 1, FIG. 2 and FIG. 4 thereof, a new personal-care product applicator embodying the principles and concepts of the present invention and generally designated by the reference numeral 14 will be described.

As shown in FIGS. 1 through 4, the personal-care product applicator 14 is a device having an elongated handle portion 5 at one end and a body portion 6 at the distal end thereof. The elongated handle portion 5 may be smooth or preferably have finger notches 7 to enhance a manual grip. Preferably, the elongated handle portion 5 has an aperture 8 located at the end thereof. The personal-care product applicator 14 may be composed of any material and is preferably molded from any suitable plastic, such as polyethylene, polypropylene, polyvinyl chloride and the like.

As shown in FIG. 4 a dispensing pocket 10 is mounted to the underside of the body portion 6 of the personal-care product applicator 14. The dispensing pocket 10 is formed of a permeable material. The dispensing pocket 10 may be formed of any suitable permeable material and is preferably formed of a nylon and spandex blend fabric. The dispensing pocket 10 has an inlet opening 11. The inlet opening 11 has a closure 12 for sealing. The closure 12 may be composed of any suitable material and is preferably elastic.

FIG. 3 depicts an alternative embodiment, wherein a layer of a non-porous cushion material, preferably sheet foam 9 is attached to the underside of the body portion 6 of the personal-care product applicator 14 prior to mounting the dispensing pocket 10 thereunto, to enhance the comfort of the application when the personal-care product applicator 14 contacts the physical body.

In use with products consisting of lotion, foam, gel, cream, powder, ointment, and salves; the user places the product into the dispensing pocket 10 of the personal-care product applicator 14 through the inlet opening 11 of the dispensing pocket 10 wherein it is sealed by the closure 12. The product is thereby retained in the dispensing pocket 10 while the personal-care product applicator 14 is maneuvered to the desired area of the physical body. When the desired area of the physical body is reached, the dispensing pocket 10 is smoothed over the skin, whereby the product is dispensed directly through, and applied by, the permeable material of the dispensing pocket 10. This procedure is repeated or the personal-care product applicator 14 is rinsed with soap and water and stored for future use.

In use with liquid or oil type products; a cotton ball is saturated with the product. The saturated cotton ball is then placed into the dispensing pocket 10 of the personal-care product applicator 14 through the inlet opening 11 of the dispensing pocket 10 wherein it is sealed by the closure 12. The saturated cotton ball is thereby retained in the dispensing pocket 10 while the personal-care product applicator 14 is maneuvered to the desired area of the physical body. When the desired area of the physical body is reached, the dispensing pocket 10 is smoothed over the skin, whereby the product is dispensed directly through the permeable material of the dispensing pocket 10. The cotton ball is removed and disposed of, and the procedure is repeated, or the personal-care product applicator 14 is rinsed with soap and water and stored for future use.

In use with spray type products; the product is sprayed directly onto the outside of the dispensing pocket 10 of the personal-care product applicator 14. The personal-care product applicator 14 is maneuvered to the desired area of the physical body, whereby the product is applied, as the dispensing pocket 10 is smoothed over the skin of the user. This procedure is then repeated or the personal-care product applicator 14 is rinsed with soap and water and stored for future use.

In use, in a bath or shower setting with a liquid or bar soap; the product is placed into the dispensing pocket 10 of the personal-care product applicator 14 through the inlet opening 11 of the dispensing pocket 10 wherein it is sealed by the closure 12. The product is thereby retained in the dispensing pocket 10 while the personal-care product applicator 14 is maneuvered to the desired area of the physical body, whereby it is dispensed directly through the permeable material of the dispensing pocket 10, when the permeable material of the dispensing pocket 10 is moistened and the dispensing pocket 10 is smoothed over the skin of the desired area. The personal-care product applicator 14 is then rinsed and stored for future use.

In use, as a personal-cooling device; an ice cube is placed into the dispensing pocket 10 of the personal-care product applicator 14 through the inlet opening 11 of the dispensing pocket 10 wherein it is sealed by the closure 12. The ice cube is thereby retained in the dispensing pocket 10 while the personal-care product applicator 14 is maneuvered to the desired area of the physical body. The skin is cooled as the dispensing pocket 10 is smoothed over the desired area and the heat of the physical body melts the ice and delivers the moisture directly through the permeable material of the dispensing pocket 10 to the skin of user. When the ice is melted the procedure is repeated or the personal-care product applicator 14 is cleaned and stored for future use.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A personal-care product applicator, designed to dispense and apply a wide variety of substances including liquid, solid, lotion, foam, gel, cream, power, ointment, oil, spray and salves to the physical body, including hard to reach areas comprising:
(a) a device having proximal and distal ends, said proximal end defining an elongated handle portion, said distal end defining a predetermined body portion, and
(b) a dispensing pocket, mounted to the underside of said predetermined body portion, formed of a permeable material, as to enable a substance to flow through, having an inlet opening, said inlet opening having a closure for sealing,
whereby said device provides the means for a substance to be received and retained, then dispensed and applied to the physical body including hard to reach areas.

2. The personal-care product applicator of claim 1 wherein said elongated handle portion comprises finger notches.

3. The personal-care product applicator of claim 2 wherein said elongated handle portion comprises an aperture at the end thereof.

4. The personal-care product applicator of claim 1, further including a layer of non-porous cushion material.

5. A personal-care product applicator, designed to dispense and apply a wide variety of substances including liquid, solid, lotion, foam, gel, cream, powder, ointment, oil, spray and salves to the physical body, including hard to reach areas comprising:
(a) a device having proximal and distal ends, said proximal end defining an elongated handle portion, said distal end defining a predetermined body portion, and
(b) an attached means for receiving, retaining, then dispensing and applying a substance to the physical body, formed of a permeable material, as to enable a substance to flow through, having an inlet opening, said inlet opening having a closure for sealing and
(b′) a dispensing pocket for receiving.

6. The personal-care product applicator of claim 5 wherein said elongated handle portion comprises finger notches.

7. The personal-care product applicator of claim 6 wherein said elongated handle comprises an aperture at the end thereof.

8. The personal-care product applicator of claim 5, further including a layer of non-porous cushion material.

9. A method for applying a substance to the physical body, comprising:
(a) providing a personal-care product applicator comprising a device having proximal and distal ends, said proximal end defining an elongated handle portion, said distal end defining a predetermined body portion, and a dispensing pocket, mounted to the underside of said predetermined body portion, formed of a permeable material, as to enable a substance to flow through, having an inlet opening, said inlet opening having a closure for sealing,
(b) providing said substance and placing said substance into said dispensing pocket of said personal-care product applicator,
(c) maneuvering said personal-care product applicator to desired area of physical body,
(d) smoothing said dispensing pocket of said personal-care product applicator over said desired area of said physical body,
whereby said substance is dispensed directly through, and applied by, said permeable material of said dispensing pocket when said dispensing pocket is smoothed over said desired area of said physical body.

10. The method of claim 9 wherein said elongated handle portion comprises finger notches.

11. The method of claim 10 wherein said elongated handle portion comprises an aperture at the end thereof.

12. The method of claim 9, further including a layer of non-porous cushion material.
